(19) United States
(12) Patent Application Publication
(10) Pub. No.: US 2011/0187374 A1
(43) Pub. Date: Aug. 4, 2011

(54) Microresistivity Imaging with Differentially Raised Electrodes

(75) Inventor: Tsili Wang, Katy, TX (US)

(73) Assignee: SMITH INTERNATIONAL, INC., Houston, TX (US)

(21) Appl. No.: 12/699,111

(22) Filed: Feb. 3, 2010

(51) Int. Cl. G01V 3/00

(52) U.S. Cl. 324/369

(57) ABSTRACT

A microresistivity logging tool includes a measuring electrode deployed in and electrically isolated from a guard electrode. The measuring electrode is radially recessed with respect to at least a portion of the guard electrode. The raised portion of the guard electrode preferably extends radially outward from the tool body such that it contacts the borehole wall during drilling. A return electrode is spaced and electrically insulated from the guard electrode. Tools in accordance with the present invention enable good current focusing to be achieved while at the same time providing protection for the measuring electrode.

### RELATED APPLICATIONS

None.

### FIELD OF THE INVENTION

The present invention relates generally to microresistivity logging while drilling measurements. More particularly, embodiments of this invention relate to a logging while drilling tool having differentially raised microresistivity electrodes.

### BACKGROUND OF THE INVENTION

The use of electrical measurements in prior art downhole applications, such as logging while drilling (LWD) and wireline logging applications, is well known. Such techniques may be utilized to determine a subterranean formation resistivity, which, along with formation porosity measurements, may be used to indicate the presence of hydrocarbons in the formation. For example, it is known in the art that porous formations having a high electrical resistivity often contain hydrocarbons, such as crude oil, while porous formations having a low electrical resistivity are often water saturated. It will be appreciated that the terms resistivity and conductivity are often used interchangeably in the art. Those of ordinary skill in the art will readily recognize that these quantities are reciprocals and that one may be converted to the other via simple mathematical calculations. Mention of one or the other herein is for convenience of description, and is not intended in a limiting sense.

Microresistivity measurements of a subterranean formation are commonly made by focusing an electrical current into the formation. Microresistivity sensors generally include at least three electrodes: at least one guard electrode, at least one return electrode, and at least one measuring electrode commonly deployed in and electrically isolated from the guard electrode. In use, an AC voltage is commonly applied between the guard and return electrodes, which results in an alternating current being passed through the formation between the guard and return electrodes. The alternating current is measured at the measuring electrode and may be used to compute an apparent resistivity in the formation opposing the electrode.

As is known to those of ordinary skill in the art, the purpose of the guard electrode is to focus electrical current into the formation so that it penetrates the formation in a substantially radial direction (i.e., in a direction orthogonal to the longitudinal axis of the borehole). Tangential and/or longitudinal current in the drilling fluid is known to cause a degradation in imaging resolution since such current provides essentially no information regarding the formation resistivity.

In logging while drilling (LWD) operations, the need to achieve both current focusing and protection of the microresistivity sensor compete with one another. Optimum current focusing is typically achieved when each of the electrodes in the sensor is in direct contact with the borehole wall (the formation). However, such a configuration can lead to excessive wearing of the electrodes and premature sensor failure. On the other hand, while a sensor that is maintained at some standoff distance from the formation (e.g., via a stabilizer blade) tends to provides for optimum electrode protection, the use of such an arrangement also tends to degrade image quality by deteriorating current focusing (especially in highly conductive drilling fluid).

Therefore there is a need in the art for an improved microresistivity sensor that provides for both improved current focusing and sensor protection.

### SUMMARY OF THE INVENTION

Aspects of the present invention are intended to address the above described need for microresistivity logging tools having improved sensors. In one exemplary embodiment, a microresistivity logging tool includes a measuring electrode deployed in and electrically isolated from a guard electrode. A return electrode is spaced and electrically insulated from the guard electrode. In this embodiment, the guard electrode includes a raised portion that extends radially outward from a tool body with respect to the measuring electrode and a recessed portion of the guard electrode that surrounds the measuring electrode. The raised portion of the guard electrode preferably extends radially outward from the tool body such that it contacts the borehole wall during drilling. The return electrode may optionally also be raised such that it contacts the borehole wall during drilling.

Exemplary embodiments of the present invention may advantageously provide several technical advantages. For example, tools in accordance with the present invention tend to advantageously enable good current focusing to be achieved while at the same time providing protection for the comparatively sensitive measuring electrode.

In one aspect the present invention includes alogging while drilling microresistivity tool. The tool includes a guard electrode configured to inject electrical current into a formation and a measuring electrode deployed in and electrically isolated from the guard electrode. An outer surface of the measuring electrode is radially recessed relative to an outer surface of at least a portion of the guard electrode. The tool further includes a return electrode spaced apart and electrically isolated from the guard electrode, the return electrode providing a return path for the electrical current.

In another aspect, the present invention includes a logging while drilling microresistivity tool. The tool includes a guard electrode configured to inject electrical current into a formation. The guard electrode includes first and second portions, an outer surface of the first portion being radially raised relative to an outer surface of the second portion. A measuring electrode is deployed in and electrically isolated from the second portion of the guard electrode, an outer surface of the measuring electrode being radially recessed relative to the outer surface of the first portion of the guard electrode. A return electrode is spaced apart and electrically isolated from the guard electrode, the return electrode providing a return path for the electrical current.

In still another aspect, the present invention includes a logging while drilling microresistivity tool. The tool includes a guard electrode configured to inject electrical current into a formation. The guard electrode includes first and second portions, an outer surface of the first portion being radially raised relative to an outer surface of the second portion. A measuring electrode is deployed in and electrically isolated from the second portion of the guard electrode, an outer surface of the measuring electrode being radially recessed relative to the outer surface of the first portion of the guard electrode. A return electrode is spaced apart and electrically isolated from the guard electrode, the return electrode providing a return path for the electrical current. The return electrode includes an outer surface that is radially raised relative to the outer surface of the second portion of the guard electrode. The outer surface of the first portion of the guard electrode and the outer surface of the return electrode are radially raised relative to an outer surface of a logging while drilling tool body upon which the electrodes are deployed.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts a conventional drilling rig on which exemplary embodiments of the present invention may be utilized.

FIG. 2 depicts one exemplary embodiment of a microresistivity tool in accordance with the present invention.

FIG. 3 depicts a longitudinal cross section of the sensor depicted on FIG. 2.

FIG. 4 depicts a longitudinal cross section of an alternative sensor embodiment in accordance with the present invention.

FIGS. 5A and 5B (collectively FIG. 5) depict a hypothetical example in accordance with the present invention.

FIGS. 6A and 6B (collectively FIG. 6) depict a comparative example.

### DETAILED DESCRIPTION

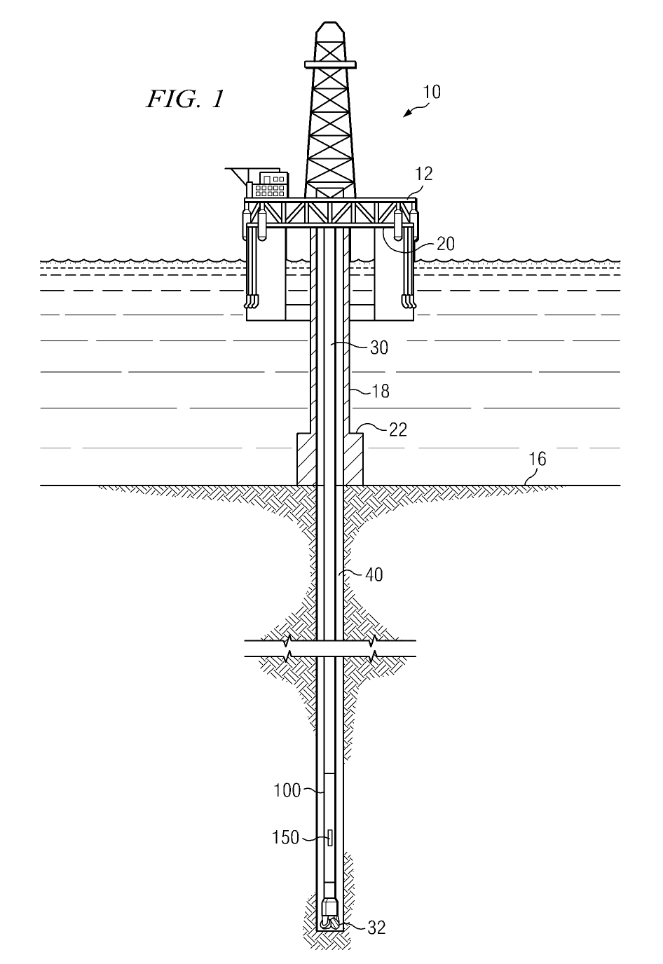

With respect to FIGS. 1 through 6, it will be understood that features or aspects of the embodiments illustrated may be shown from various views. Where such features or aspects are common to particular views, they are labeled using the same reference numeral. Thus, a feature or aspect labeled with a particular reference numeral on one view in FIGS. 1 through 6 may be described herein with respect to that reference numeral shown on other views.

FIG. 1 depicts one exemplary embodiment of a microresistivity logging while drilling tool 100 in use in an offshore oil or gas drilling assembly, generally denoted 10. In FIG. 1, a semisubmersible drilling platform 12 is positioned over an oil or gas formation (not shown) disposed below the sea floor 16. A subsea conduit 18 extends from deck 20 of platform 12 to a wellhead installation 22. The platform may include a derrick and a hoisting apparatus for raising and lowering the drill string 30, which, as shown, extends into borehole 40 and includes a drill bit 32 and logging while drilling tool 100. Embodiments of LWD tool 100 include at least one microresistivity sensor 150. Drill string 30 may further include, for example, a downhole drill motor, a mud pulse telemetry system, a steering tool, and/or one or more of numerous other MWD and LWD sensors for sensing downhole characteristics of the borehole and the surrounding formation.

It will be understood by those of ordinary skill in the art that the deployment depicted on FIG. 1 is merely exemplary for purposes of describing the invention set forth herein. It will be further understood that logging tools in accordance with the present invention are not limited to use with a semisubmersible platform 12 as illustrated on FIG. 1. Measurement tool 100 is equally well suited for use with any kind of subterranean drilling operation, either offshore or onshore.

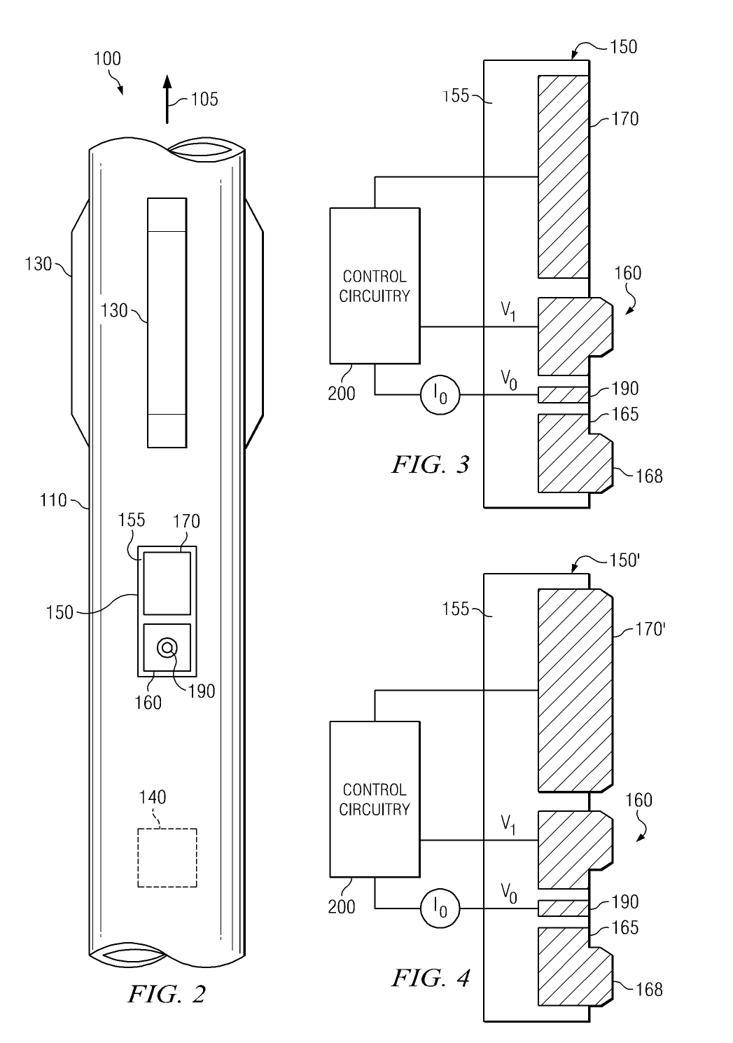

FIG. 2 depicts a portion of one exemplary embodiment of LWD tool 100. As described above with respect to FIG. 1, LWD tool 100 includes a microresistivity sensor 150 deployed on an LWD tool body 110. The exemplary tool embodiment depicted further includes a plurality of stabilizer blades 130 deployed near to the sensor 150. The stabilizer blades 130 preferably have about the same outer radius as the outermost radius of the sensor. This feature of the invention is described in more detail below with respect to FIGS. 3 and 4. It will be understood that while tool embodiments including a plurality of stabilizer blades are preferred for certain applications, the invention is not limited to embodiments utilizing stabilizer blades.

LWD tool 100 may optionally further include an azimuth sensor 140 configured to measure the azimuth angle (toolface angle) of the microresistivity sensor 150 in substantially real time during drilling. Suitable azimuth sensors typically include one or more accelerometers, magnetometers, and/or gyroscopes and are well known in the art. It will be understood that the invention is not limited to any particular azimuth sensor configuration or even to the use of an azimuth sensor.

With continued reference to FIG. 2, microresistivity sensor 150 includes a measuring electrode 190 deployed in and electrically insulated from a guard electrode 160. A spaced apart return electrode 170 provides a return path for electrical current injected by the measuring and guard electrodes. Electrodes 160 and 170 are electrically isolated from one another via a conventional electrically insulating material 155 (which is also referred to herein as a sensor body).

It will be understood by those of ordinary skill in the art that the invention is not limited to the particular sensor configuration depicted on FIG. 2. In alternative embodiments, the electrodes may be deployed concentrically about one another, for example, with the measuring electrode deployed innermost, the guard electrode deployed about the measuring electrode, the dual function electrode deployed about the guard electrode, and the return deployed about the dual function electrode. In other alternative embodiments, the guard electrode may extend circumferentially about the entire tool body. In still other alternative embodiments the electrodes may be circumferentially or obliquely spaced on the tool body as opposed to longitudinally spaced as depicted on FIG. 2. The invention is not limited in regards to the spacing and/or shape of the electrodes.

In the exemplary embodiment depicted, a long axis of the microresistivity sensor is substantially parallel with a longitudinal axis 105 of the tool 100. While this configuration is generally preferred for achieving optimum azimuthal coverage, the invention is expressly not limited in these regards.

Turning now to FIG. 3, the exemplary sensor embodiment depicted on FIG. 2 is shown in longitudinal cross section. As depicted, the guard electrode 160 includes a radially raised portion 168 that extends radially outward from the tool body and the sensor body and a radially recessed portion 165 (recessed relative to the raised portion). The measuring electrode 190 is also radially recessed with respect to the raised portion 168 of the guard electrode 160. In preferred embodiments, the radial extent of the guard electrode is about equal to that of the stabilizer blades 130 depicted on FIG. 2 (in embodiments including such stabilizer blades). For optimal current focusing, the raised portion 168 of the guard electrode 160 preferably contacts the borehole wall during microresistivity LWD measurements.

The radially recessed portion 165 of the guard electrode 160 preferably surrounds and is concentric with the measuring electrode 190. Moreover, the outer radius of the measuring electrode is preferably substantially equal to the outer radius of the recessed portion 165 of the guard electrode 160. In the exemplary embodiment depicted, the measuring electrode 190 and the recessed portion 165 are recessed such that their outer radii are substantially equal to an outer radius of the insulative sensor body 155, although the invention is not limited in this regard.

One aspect of the present invention was the realization that certain portions of a microresistivity sensor are more susceptible to mechanical wear and degradation than are other portions. For example, it was realized that the measuring electrode 190 is particularly susceptible to wear and other damage in the borehole environment. Moreover, it was realized that the integrity of the measuring electrode 190 is critical to sensor performance in that the measuring electrode measures electrical currents that are used to compute the apparent resistivity of the formation. Even relatively minor damage to the measuring electrode 190 may adversely effect current measurement (and therefore result in erroneous resistivity measurements). It was further realized that the portion 165 of the guard electrode 160 immediately surrounding the measuring electrode 190 tends to most strongly focus the current in the measuring electrode 190. Deformation to that portion 165 of the guard electrode 160 may potentially adversely effect current focusing.

In embodiments in accordance with the present invention, the raised portion 168 of the guard electrode 160 is radially extended relative to the measuring electrode 190 and recessed portion 165. The raised portion 168 of the guard electrode 160 tends to promote suitable current focusing into the formation while at the same time serving to protect the more sensitive measuring electrode 190 and radially recessed portion 165.

FIG. 4 depicts an alternative sensor embodiment 150′ in accordance with the present invention. The guard 160 and measuring 190 electrode configuration of sensor 150′ is essentially identical to that of sensor 150 with one exception. Sensor 150′ differs from sensor 150 in that it also includes a raised return electrode 170′. In the exemplary embodiment depicted the radius of the return electrode 170′ is substantially the same as that of the raised portion 168 of the guard electrode 160. Sensor embodiment 150′ may advantageously reduce wear (and therefore extend the surface life of the sensor) in that it provides additional surface area in contact with the borehole wall. Those of ordinary skill in the art will readily appreciate that that electrodes 160 and 170′ may be advantageously fabricated from electrically conductive, wear resistant materials known in the art.

It will be understood that the present invention is not limited to embodiments having only three electrodes (the guard, measuring, and return electrodes depicted on FIG. 3). Suitable embodiments may include substantially any number of electrodes. For example, exemplary sensor embodiments may further include a dual function electrode (also referred to as a shield electrode) deployed between and electrically insulated from the guard 160 and return 170 electrodes. The dual function electrode may be raised or recessed. The invention is not limited in these regards.

Co-pending, commonly assigned, and commonly invented U.S. patent application Ser. No. 12/581,237, which is fully incorporated by reference herein, discloses a logging tool having a dual function electrode deployed between and electrically isolated from a guard electrode and a return electrode. A drive circuit enables the electrical potential of the dual function electrode to be independently controlled so as to control the depth of investigation of the sensor. At low potentials, the dual function electrode tends to function as a return electrode resulting in a sensor having a relatively shallow depth of investigation. At high potentials, the dual function electrode tends to function as a guard electrode resulting in a sensor having a greater depth of investigation.

Co-pending, commonly assigned, and commonly invented U.S. patent application Ser. No. 12/581,245, which is also fully incorporated by reference herein, discloses a logging tool having a shield electrode deployed between and electrically isolated from a guard electrode and a return electrode. First and second potential electrodes are deployed in and electrically isolated from the shield electrode. The sensor further includes at least one switch (or switching mechanism) configured to switch the sensor between distinct first and second microresistivity measurement modes. The first measurement mode is configured for making microresistivity measurements in conductive drilling fluid and the second measurement mode is configured for making microresistivity measurements in non-conductive drilling fluid.

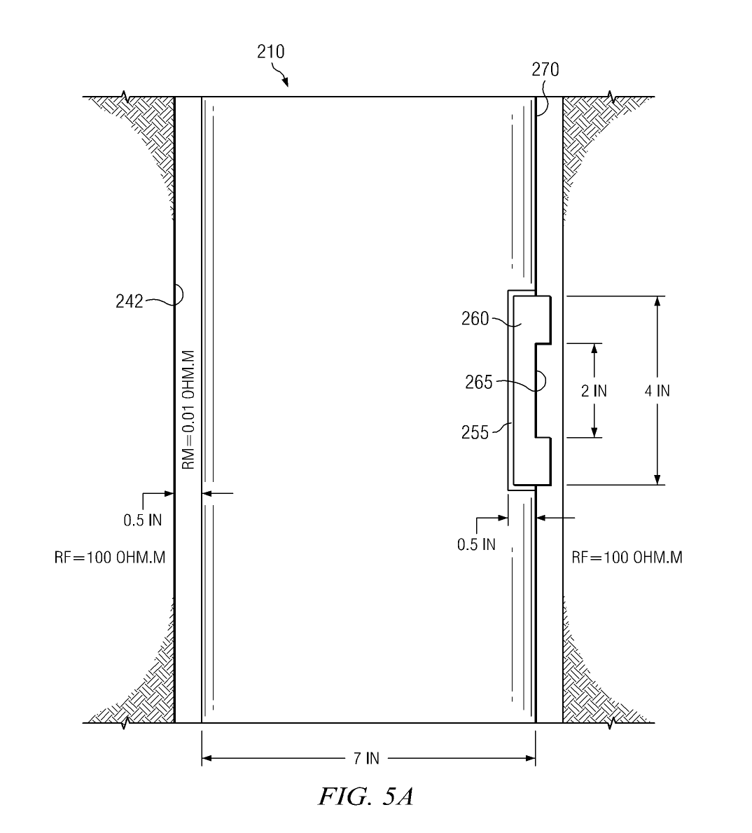

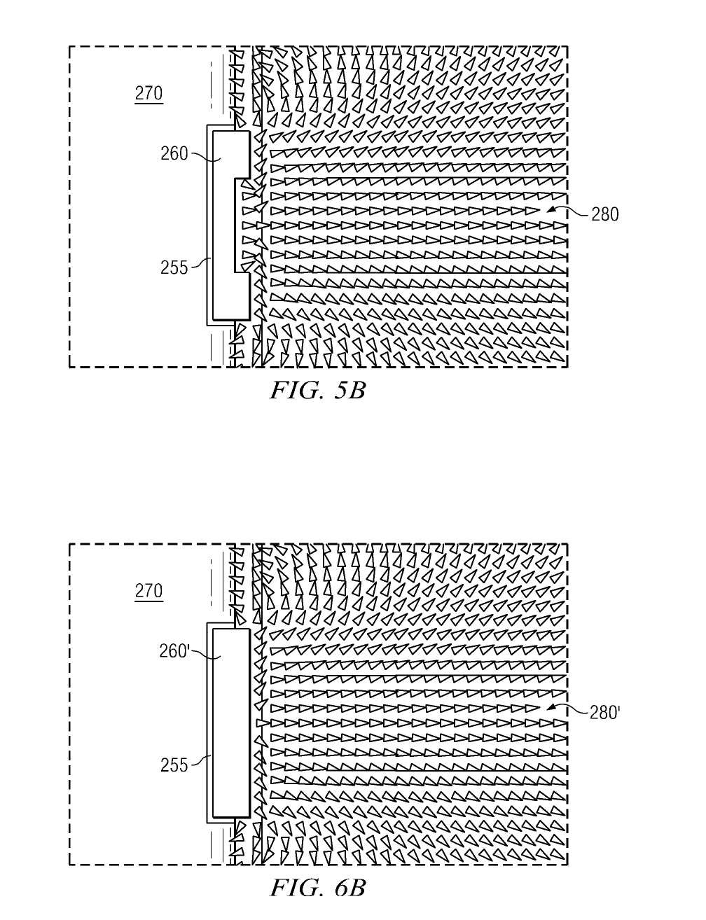

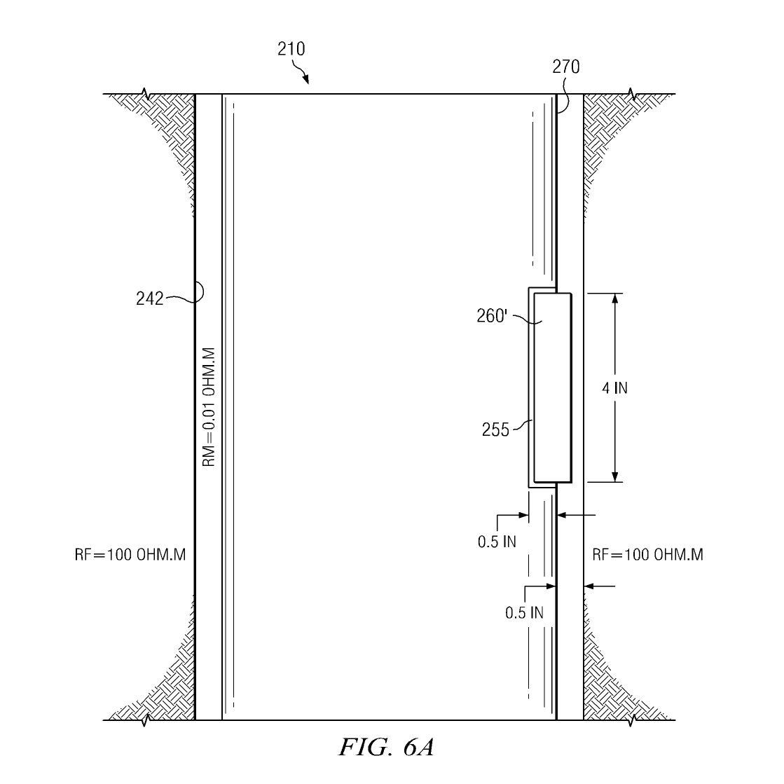

The present invention is now described in further detail with respect to the following example, which is intended to be purely exemplary and therefore should not be construed in any way as limiting its scope. In this example, injected currents were mathematically modeled for a hypothetical guard electrode including a recessed portion in accordance with the present invention (FIGS. 5A and 5B) and a comparative prior art guard electrode configuration including no recess (FIGS. 6A and 6B).

FIG. 5A depicts a tool body 210 deployed in subterranean borehole 242. In this example, the tool body 210 included a guard electrode 260 having a recessed portion 265 in accordance with the present invention. The guard electrode 260 was electrically isolated from a return electrode 270 via insulating material 255. In the exemplary embodiment depicted, guard electrode 260 had an axial dimension of 4 inches while the recessed portion 265 had an axial dimension of 2 inches. The tool body 210 had a diameter of 7 inches and was concentrically deployed in a borehole 242 having a diameter of 8 inches. In this example, the drilling fluid had a resistivity, Rₘ, equal to 0.01 ohm·m while the formation had a resistivity, Rf, equal to 100 ohm·m. The prior art configuration depicted on FIG. 6A is identical to that depicted on FIG. 5A with the exception that the tool body 210 included a non-recessed guard electrode 260′.

FIGS. 5B and 6B depict theoretical plots of electrical current injected into the subterranean formation for the models depicted on FIGS. 5A and 6A upon application of a one volt AC drive voltage. As depicted, the theoretical injected currents (and current distributions) were substantially identical indicating that a guard electrode including recessed portion does not adversely affect the current injection and current focusing functionality of the electrode.

With reference again to FIGS. 2-4, it will be understood that the controller 200 is typically further configured to control the current and/or the voltage at the guard 160 and measuring 190 electrodes. In order to achieve optimal focusing, the voltages at the guard and measuring electrodes are typically held equal to one another (i.e., V₀=V₁). Methods for achieving such voltage control during microresistivity LWD operations are known in the art and are therefore discussed no further herein. The controller 200 is typically further configured to measure the electrical current I₀ in the measuring electrode. The controller may further be configured to compute an apparent microresistivity, for example, using mathematical relationships known to those of ordinary skill in the art.

A suitable controller 200 typically includes a programmable processor (not shown), such as a microprocessor or a microcontroller, and may also include processor-readable or computer-readable program code embodying logic, including instructions for controlling the function of the tool. A suitable controller may be utilized, for example, to make microresistivity measurements while drilling. As such the controller may further be configured to: (i) inject an alternating electrical current into a formation at the guard electrode, (ii) measure the electrical current in the measuring electrode, and (iii) compute an apparent resistivity using the measured electrical current.

A suitable controller 200 may also be configured to construct LWD microresistivity images of the subterranean formation. In such imaging applications, the microresistivity measurements may be acquired and correlated with corresponding azimuth measurements (obtained, for example, from the directional sensors 140 deployed in the tool 100) while the tool rotates in the borehole. As such, the controller may therefore include instructions for temporally correlating LWD sensor measurements (or computed resistivity values) with sensor azimuth (toolface) measurements. The LWD sensor measurements may further be correlated with depth measurements. Borehole images may be constructed using substantially any known methodologies, for example, including conventional binning, windowing, or probability distribution algorithms. U.S. Pat. No. 5,473,158 discloses a conventional binning algorithm for constructing a borehole image. Commonly assigned U.S. Pat. No. 7,027,926 to Haugland discloses a technique for constructing a borehole image in which sensor data is convolved with a one-dimensional window function. Commonly assigned U.S. Pat. No. 7,558,675 to Sugiura discloses an image constructing technique in which sensor data is probabilistically distributed in either one or two dimensions.

A suitable controller may also optionally include other controllable components, such as other sensors, data storage devices, power supplies, timers, and the like. As described above, the controller is disposed to be in electronic communication with the various sensors deployed in the drilling system. The controller may also optionally be disposed to communicate with other instruments in the drill string, such as telemetry systems that further communicate with the surface or a steering tool. Such communication can significantly enhance directional control while drilling, for example, by enabling measured and/or computed parameters to be transmitted to the surface. These parameters may be used, for example, to make steering decisions during drilling. A controller may further optionally include volatile or non-volatile memory or a data storage device for downhole storage of measured currents, microresistivity values, and/or LWD images. The invention is not limited in these regards.

Although the present invention and its advantages have been described in detail, it should be understood that various changes, substitutions and alternations can be made herein without departing from the spirit and scope of the invention as defined by the appended claims.

I claim:

1. A logging while drilling microresistivity tool comprising:
a logging while drilling tool body;
a guard electrode configured to inject electrical current into a formation;
a measuring electrode deployed in and electrically isolated from the guard electrode, an outer surface of the measuring electrode being radially recessed relative to an outer surface of at least a portion of the guard electrode; and
a return electrode spaced apart and electrically isolated from the guard electrode, the return electrode providing a return path for the electrical current.

2. The logging tool of claim 1, wherein the guard electrode comprises first and second portions, an outer surface of the first portion being radially raised relative to an outer surface of the second portion.

3. The logging tool of claim 2, wherein the second portion of the guard electrode surrounds the measuring electrode.

4. The logging tool of claim 2, wherein the second portion of the guard electrode is concentric with the measuring electrode.

5. The logging tool of claim 2, wherein an outer radius of the second portion of the guard electrode is substantially equal to an outer radius of the measuring electrode.

6. The logging tool of claim 5, wherein the outer radius of the second portion of the guard electrode and the outer radius of the measuring electrode are substantially equal to an outer radius of an electrically insulative sensor body.

7. The logging tool of claim 1, wherein at least a portion of the return electrode is radially raised relative to the measuring electrode.

8. The logging tool of claim 1, wherein an outer radius of the return electrode is substantially equal to an outer radius of the guard electrode.

9. The logging tool of claim 1, further comprising a stabilizer deployed on the tool body, the stabilizer having a plurality stabilizer blades that extend radially outward from the tool body.

10. The logging tool of claim 9, wherein an outer radius of at least one of the stabilizer blades is substantially equal to an outer radius of the guard electrode.

11. The logging tool of claim 1, further comprising a controller configured to: (i) cause the guard electrode to inject an alternating electrical current into a formation, (ii) cause the measuring electrode to measure a corresponding electrical current, and (iii) compute an apparent resistivity using said measured electrical current.

12. A logging while drilling microresistivity tool comprising:
a logging while drilling tool body;
a guard electrode configured to inject electrical current into a formation, the guard electrode including first and second portions, an outer surface of the first portion being radially raised relative to an outer surface of the second portion;
a measuring electrode deployed in and electrically isolated from the second portion of the guard electrode, an outer surface of the measuring electrode being radially recessed relative to the outer surface of the first portion of the guard electrode; and
a return electrode spaced apart and electrically isolated from the guard electrode, the return electrode providing a return path for the electrical current.

13. The logging tool of claim 12, wherein the second portion of the guard electrode is concentric with the measuring electrode.

14. The logging tool of claim 12, wherein an outer radius of the second portion of the guard electrode is substantially equal to an outer radius of the measuring electrode.

15. The logging tool of claim 12, wherein an outer radius of the return electrode is about equal to an outer radius of the first portion of the guard electrode.

16. The logging tool of claim 12, further comprising a stabilizer deployed on the tool body, the stabilizer having a plurality stabilizer blades that extend radially outward from the tool body, an outer radius of at least one of the stabilizer blades being substantially equal to an outer radius of the first portion of the guard electrode.

17. The logging tool of claim 12, wherein the outer surface of the first portion of the guard electrode is radially raised relative to an outer surface of the tool body.

18. A logging while drilling microresistivity tool comprising:
a logging while drilling tool body;
a guard electrode configured to inject electrical current into a formation, the guard electrode including first and second portions, an outer surface of the first portion being radially raised relative to an outer surface of the second portion;
a measuring electrode deployed in and electrically isolated from the second portion of the guard electrode, an outer surface of the measuring electrode being radially recessed relative to the outer surface of the first portion of the guard electrode;
a return electrode spaced apart and electrically isolated from the guard electrode, the return electrode providing a return path for the electrical current, the return electrode having an outer surface that is radially raised relative to the outer surface of the second portion of the guard electrode;
the outer surface of the first portion of the guard electrode and the outer surface of the return electrode being radially raised relative to an outer surface of the tool body.

19. The logging tool of claim 18, wherein the second portion of the guard electrode is concentric with the measuring electrode.

20. The logging tool of claim 18, wherein outer radii of the second portion of the guard electrode, the measuring electrode, and an insulative sensor body are substantially equal.

21. The logging tool of claim 18, further comprising a stabilizer deployed on the tool body, the stabilizer having a plurality stabilizer blades that extend radially outward from the tool body, an outer radius of at least one of the stabilizer blades being substantially equal to an outer radius of the first portion of the guard electrode.
